(19) United States
(12) Patent Application Publication
(10) Pub. No.: US 2023/0007907 A1
(43) Pub. Date: Jan. 12, 2023

(54) TECHNIQUE FOR MARKING A PROLATE OBJECT

(71) Applicant: Phoenix Contact GmbH & Co. KG, Blomberg (DE)

(72) Inventors: Kilian Klages, Detmold (DE); Alexander Hofmann, Hameln (DE); Markus Traenkle, Dauchingen (DE); Juergen Gretscher, Dornhan (DE); Benjamin Aberle, Dunningen (DE)

(21) Appl. No.: 17/765,461

(22) PCT Filed: Oct. 6, 2020
(86) PCT No.: PCT/EP2020/077972

§ 371 Date: Sep. 30, 2022

(30) Foreign Application Priority Data
Oct. 9, 2019 (BE) BE2019/5664

(51) Int. Cl. B41J 3/407; B41J 2/32; B41J 29/393; B41J 3/44; B65C 11/02; B65C 3/02; H01B 13/34

(52) U.S. Cl. CPC B41J 3/4073; B41J 2/32; B41J 29/393; B41J 3/4075; B41J 3/44; B65C 11/02; B65C 3/02; H01B 13/344

(57) ABSTRACT

A device for providing a marking arranged or arrangeable in a circumferentially closed manner around a prolate object includes: a material interface for receiving a printed product output from a printer; a print signal interface for acquiring a control signal related to the printed product output; at least one sensor for acquiring a control signal related to providing of the marking; and at least one actuator for arranging the marking on the object in a circumferentially closed manner or to provide the marking for circumferentially closed arrangement depending on the control signal related to the printed product output and the control signal related to the providing of the marking using the printed product output by the printer.

### CROSS-REFERENCE TO PRIOR APPLICATIONS

This application is a U.S. National Phase application under 35 U.S.C. § 371 of International Application No. PCT/EP2020/077972, filed on Oct. 6, 2020, and claims benefit to Belgian Patent Application No. BE 2019/5664, filed on Oct. 9, 2019. The International Application was published in German on Apr. 15, 2021 as WO/2021/069425 under PCT Article 21(2).

### FIELD

The invention relates to a technique for marking a prolate object, for example a conductor. In particular, the invention relates to a device for providing a marking that is arranged or arrangeable in a circumferentially closed manner around a prolate object.

### BACKGROUND

The marking of, for example, electrical conductors is conventionally done using label printers to print a label, which then has to be mounted on the conductor by manual work after the printing. Document US 2003/146943 A1 describes a printer that alternately prints and cuts a label.

Furthermore, special printers are known which may be used for conductor labeling. Document US 2004/0211522 A1 describes a machine that winds a pre-printed wrap-around label around a conductor taken from a spindle roll. Document US 2008/0073023 A1 describes a monolithic machine for printing and applying wrap-around labels.

However, conventional devices can only print certain labels and, if a technique for automatically applying is integrated, no other printing applications are possible with such a device.

### SUMMARY

In an embodiment, the present invention provides a device for providing a marking arranged or arrangeable in a circumferentially closed manner around a prolate object, comprising: a material interface configured to receive a printed product output from a printer; a print signal interface configured to acquire a control signal related to the printed product output; at least one sensor configured to acquire a control signal related to providing of the marking; and at least one actuator configured to arrange the marking on the object in a circumferentially closed manner or to provide the marking for circumferentially closed arrangement depending on the control signal related to the printed product output and the control signal related to the providing of the marking using the printed product output by the printer.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic sectional view of a first embodiment of a device for providing a marking attached to an embodiment of a printer;

FIG. 2 shows a schematic sectional view of a second embodiment of the device for providing a marking in a first state;

FIG. 3A shows a schematic sectional view of a second embodiment of the device for providing a marking in a second state;

FIG. 3B shows a schematic sectional view of a variant of the second embodiment of the device for providing a marking in a second state;

FIG. 4 shows a schematic sectional view of a third embodiment of a device for providing a marking in a first state;

FIG. 5 shows a schematic sectional view of a third embodiment of a device for providing a marking in a second state;

FIG. 6 shows a schematic sectional view of an embodiment of a printer as a thermal transfer printer;

FIG. 7A shows a schematic perspective view of an exemplary printing system comprising an embodiment of the printer and an embodiment of the device for providing a marking in a mounted (or attached) position; and

FIG. 7B shows a schematic perspective view of the exemplary printing system of FIG. 7A in a disassembled (or detached) position.

### DETAILED DESCRIPTION

In an embodiment, the present invention provides a device for a printing system, preferably with the size and portability of a desktop device, so that the system may be converted in a short time to different applications of object marking, preferably different applications of conductor marking. The ability to quickly and easily convert the printing system starting from a normal or application-unspecific label printer may be provided, so that the device supports the application of the marking on a prolate object, preferably a conductor.

One aspect relates to a device for providing a marking arranged or arrangeable in a circumferentially closed manner around a prolate object, preferably around a conductor. The device comprises a material interface configured to receive a printed product output from a printer. Alternatively or additionally, the device comprises a print signal interface configured to acquire (e.g., detect) a control signal related to (e.g., for) the outputting of the printed product. Alternatively or additionally, the device comprises at least one sensor configured to acquire (e.g., detect) a control signal related to (e.g., for) the providing of the marking. Alternatively or additionally, the device comprises at least one actuator that is configured to arrange the marking on the object in a circumferentially closed manner or to provide the marking for circumferentially closed arrangement, depending on the control signal related to (e.g., for) the outputting of the printed product and the control signal related to (e.g., for) the providing of the marking, using the printed product output by the printer.

The device may be a device for circumferentially arranging a printed marking (or label) around a prolate object, preferably around a conductor.

The device may be configured as an applicator, front annex or attachment of the printer, in particular of a thermal transfer printer. The device may be exchangeable. A. Each of a plurality of different embodiments of the devices may be selectively attachable to the same printer.

The printer may receive an identifier via an interface (e.g., a network interface or a serial interface). The printer may be configured to print the received identifier onto a printing medium using a printing material. The printing material may comprise a color ribbon, such as for thermal transfer printing. The printing medium (i.e., a printing substrate or label material or material to print on) may be a plastic film, for example for heat sealing or welding, or a heat shrink tube. The printed product may comprise the printing medium printed using the printing material.

The providing may comprise arranging the marking on the prolate object, preferably arranging the marking circumferentially about a longitudinal axis of the prolate object. The at least one actuator may be configured to arrange the printed marking circumferentially about a longitudinal axis of the object.

For example, the actuator may arrange or provide the marking when the control signal of the print signal interface indicates the output of the printed product at the material interface and the control signal of the sensor indicates the presence of the object or a request (or desired use) to provide the marking.

The device and the printer may be arranged next to each other or side by side, for example without a direct mechanical connection. For example, the printer and device may each be arranged in a stationary and/or non-slip manner on the same work surface. For example, a material interface of the printer may be aligned or overlapping (or congruent) with or covered by the material interface of the device. There may be a clear gap between the printer and the device during operation.

The device may further comprise a mechanical interface configured to releasably or irreversibly attach (or mounted or fasten) the device to the printer.

The attaching (or mounting or fastening) may be irreversible, for example comprising a material connection (i.e., may be materially bonded). Alternatively, the device may be releasably (or removably) attached to the printer, such as being non-destructively detachable and/or attachable and/or detachable without tools.

The at least one sensor of the control signal for providing the marking may be configured to sense (e.g., acquire) or detect the object, preferably to detect a presence, a location, and/or a size of the object.

The control signal for providing the marking may indicate the presence (i.e., the presence), the location, and/or the size of the object. The location may comprise a position and/or orientation of the object (for example, a longitudinal axis of the object). The size may comprise a length (for example, along the longitudinal axis), a width, a diameter, and/or a circumference of the object.

The at least one sensor of the control signal for providing the marking may detect or acquire the object without contact.

The at least one sensor of the control signal for the providing the marking may comprise a push button. The control signal for the providing the marking (also: control signal for the provision of the marking or marking provision control signal) may indicate an actuation of the button (also: provision request).

The control signal for providing the marking may indicate a user request for providing the marking. The control signal for providing the marking may be a trigger signal. The actuator may be configured to arrange the marking on the object in a circumferentially closed (e.g., loop) manner or to provide the marking for circumferentially closed arrangement in response to the detection of the object and/or the acquiring of the trigger signal.

The button may be a foot switch or a hand switch.

The print signal interface may comprise a sensor configured to sense (e.g., detect or acquire) the output of the printed product output by the printer, preferably to sense (e.g., detect or acquire) a presence, a position, and/or a feed of the output printed product.

The sensor for detecting the output of the printed product (also: sensor for detecting the output of the printed product, or in short: sensor for detecting the printed product) may be arranged at the material interface. The sensor for detecting the printed product may detect the printed product without contact (i.e., contactless).

The at least one sensor may further comprise a sensor for detecting the printed product output from the printer. Detecting the printed product may comprise detecting the presence, a location (e.g., position and/or orientation), and/or a size (e.g., length and/or diameter) of the printed product.

Alternatively or additionally, the print signal interface may comprise a data interface configured to communicate, preferably bidirectionally, with the printer for providing or arranging the marking.

The at least one actuator may be configured to (for example, in response to detecting the object and/or acquiring the trigger signal) process, in communication with the printer, the printed product output by the printer for marking and to arrange, or provide for arrangement of, the marking on the object.

The bidirectional communication may comprise receiving the control signal for outputting the printed product from the printer and sending a control signal for requesting output of the printed product to the printer. For example, the control signal for providing the marking may be forwarded to the printer via the data interface as a request for output of the printed product.

The printer may be configured to deliver the printed product to the device at the material interface, for example, in accordance with the bidirectional communication and/or in response to the control signal to provide the marking.

The data interface may be configured for wireless communication, preferably using radio signals, infrared signals, and/or near-field communication.

The data interface may be configured to synchronize or coordinate an alternating and/or event-driven operation of the at least one actuator and the printer to provide or arrange the marking.

For example, a feed (e.g., feed forward) of the printed product performed by the printer may be alternately performed, synchronized, and/or coordinated with a cutting, folding, and/or wrapping of the output printed product. The respective sub-steps executed during alternating and/or event-driven operation by the device or the printer for the providing or the arranging of the marking may also be referred to as actions. The coordination of the sub-steps may also be referred to as action coordination.

The data interface may be configured to enable the printer to control the at least one actuator of the device, to read control signals from the at least one sensor and/or the print signal interface of the device, and/or to read an identifier stored in the device.

The at least one actuator of the device may be controlled or controllable on the printer side using the data interface. Alternatively or additionally, measurands (or measured values) of the at least one sensor of the device may be queried (e.g., retrieved or requested) using the data interface.

The data interface may be electrically connected within the device to the at least one actuator and/or the at least one sensor.

The data interface may be configured to receive control commands for controlling or regulating the at least one actuator from the printer and/or to send control commands for controlling or regulating the printer to the printer based on the control signals from the at least one sensor and/or the print signal interface.

The data interface may be electrically connected to the at least one actuator and/or the at least one sensor within the device via a control unit and/or a regulating unit. The control unit and/or regulating unit may determine parameters of the applicator from the acquired measured values. The control commands sent to the printer may comprise the parameters and/or control the printer according to the parameters.

The data interface may be configured to send control signals (for example, control commands and/or confirmation messages) from the at least one sensor and/or the print signal interface, and/or parameters determined from the (aforementioned) control signals, to the printer for the providing or the arranging of the marking.

The device may further comprise a control unit or regulating unit configured to control or regulate the at least one actuator of the device depending on the control signals of the at least one sensor, measured values of the printer received via the data interface, confirmation messages of the printer received via the data interface, and/or control commands of the printer received via the data interface for arranging or providing the marking.

The control unit or the regulating unit may be further configured to obtain (e.g., receive) a control command from the printer via the data interface, to execute control or regulation of the at least one actuator in accordance with the control command, and to send a feedback to the printer via the data interface in response to completion of execution of the control command.

The feedback may comprise a confirmation of the (for example successful) completion of the execution of the control command or an error message regarding an error during the execution of the control command. For example, the feedback may inform the printer that a defined state of the device has been reached, such as an end position of the at least one actuator.

The control unit or regulating unit may further be configured to determine a parameter of the arranging based on the control signal detected using the at least one sensor, and to send the determined parameter to the printer via the data interface.

The detected or acquired control signal may be indicative of a diameter or circumference of the object. The determined parameter may be indicative of a length of a feed (e.g., an advance or feed forward) or a retraction of the printed product.

A control command sent from the device to the printer via the data interface may initiate the feed (e.g., advance or feed forward) or the retraction.

The control unit or regulating unit may autonomously perform the providing or arranging of the marking, or a substep of the providing or the arranging of the marking, in accordance with the control command during the time period between obtaining (e.g., receiving) the control command from the printer and sending the feedback to the printer.

The device may further comprise an electrical interface configured to supply electrical power to the device via the printer.

The data interface and/or the electrical interface may be arranged relative to the mechanical interface to contact the printer for communication or supply of electrical power to the device when the device is attached to the printer using the mechanical interface.

The data interface may be arranged relative to the mechanical interface to contact the printer for communication when the device is attached to the printer using the mechanical interface. The electrical interface may be arranged relative to the mechanical interface to contact the printer for power supply when the device is attached to the printer using the mechanical interface. For example, attaching (or mounting or fastening) the device to the printer using the mechanical interface may cause contacts of the data interface and/or the electrical interface to become connected.

The object may comprise a conductor or may be a conductor. The conductor may be a current conductor (or electrical wire) or a light guide (or optical fiber).

The mechanical interface may comprise a centering pin or an opening for receiving a centering pin and/or a lever and an eccentric connected to the lever in a rotationally fixed manner, which eccentric is configured for attaching (or fastening) the device to the printer without screws and/or without tools.

Another aspect relates to a system (also: printing system) for providing a marking arranged or arrangeable in a closed loop around a prolate object, preferably around a conductor. The system comprises a printer, preferably a thermal transfer printer, configured to output a printed product. Furthermore, the system comprises a device according to an embodiment of the device aspect, wherein the material interface may be arranged, relative to the printer, to receive the printed product output by the printer.

Embodiments of the device enable a modular system (also: printing system) that may be based on a single printer, for example a desktop device, so that this printer may be converted in a short time or few steps to the different applications of object marking, preferably conductor marking. For example, a user may quickly and easily form a system from a normal or application-unspecific label printer for assisting in applying a marking (for example, a label) to the prolate object to be marked, preferably the conductor to be marked.

Herein, the terms application and applying (preferably as a process step) may be interpreted to be synonymous or interchangeable. The terms arrangement and arranging (preferably as a process step) may be interpreted herein to be synonymous or interchangeable.

Applying the marking on or to the prolate object (preferably on or to the conductor) may comprise arranging the marking on or at the prolate object. Providing the marking arranged or arrangeable in a circumferentially closed manner around the prolate object (preferably around the conductor) may comprise cutting (preferably trimming) the printed product.

The prolate object may be an elongated object. At least in sections, the prolate object may be a (for example, general) cylinder, preferably a circular cylinder or a prism.

The prolate object may have a longitudinal axis. An extent of the object in the direction of the longitudinal axis may be greater (for example, several times greater) than one or any extent of the object transverse or perpendicular to the longitudinal axis.

The prolate object may be a conductor, a tube, a vessel, or a housing. The conductor may be an elongated object for conducting signals or substances. For example, the conductor may be an elongated object for conducting electrical current and/or electromagnetic radiation (preferably light). The vessel may be a test tube or a sample tube, for example for holding and/or transporting a fluid.

The conductor may comprise one core or two, at least two, three or more cores (or wires) electrically insulated or optically decoupled from each other. The cores may be parallel to each other or may be twisted together (for example, in pairs).

The core or the conductor may be a single wire or a plurality of, fine and/or superfine stranded conductors.

The conductor may be a cable, cable bundle, and/or ribbon cable. The conductor may be a light guide (also: optical fiber or light guide cable). The conductor may be a tube and/or a fluid line or conduit.

The conductor may be a cylindrical body and/or a non-rotationally symmetric elongated body. The conduction of the signals or substances may be directed along a longitudinal axis of the conductor and/or may extend between ends of the conductor.

By allowing embodiments of the device for a specific application to be attached to a printer that is not specific to the application, special printers for the respective application, and thus costs, can be avoided and/or resources can be used more effectively. For example, a utilization rate of the printer may be increased as a result. The same or further embodiments of the device may reduce a downstream manual effort in mounting the printing materials on the objects to be marked.

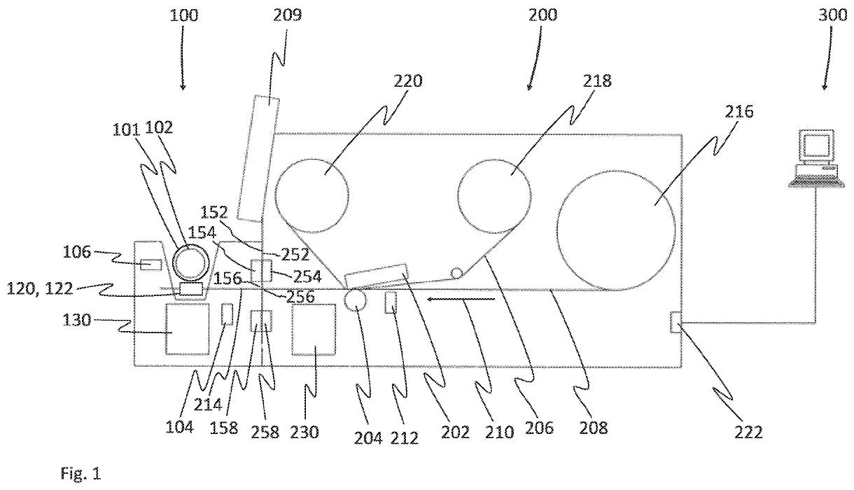

FIG. 1 shows an embodiment of a device generally designated by reference numeral 100 for providing (for example, for output, arrangement and/or application of a marking 101) arranged or arrangeable circumferentially closed around a prolate object 102, preferably around a conductor.

The device 100 comprises a material interface 156 configured to receive a printed product 214 output from a printer 200. Further, the device 100 comprises a printing signal interface (for example, a sensor generally designated herein by reference numeral 104 and/or a data interface generally designated herein by reference numeral 158) configured to acquire a control signal for outputting the printed product 214. Further, the device 100 comprises at least one sensor 106 configured to acquire a control signal for providing the marking 101.

Further, the device 100 comprises at least one actuator (for example, at least one of the actuators generally designated herein by reference numerals 120 and 122) configured to arrange the marking 101 on the object 102 in a closed circumferential manner or to provide the marking 101 for closed circumferential arrangement, depending on the control signal for outputting the printed product 214 and the control signal for providing the marking 101 using the printed product 214 output from the printer 200.

Optionally, the device 100 comprises a mechanical interface 152 configured to removably attach the device 100 to a printer 200.

For example, the print signal interface comprises a data interface 158 configured to communicate with the printer 200 for providing the printed marking 101. The control signal for outputting the printed product 214 may be received by the printer (for example, its control system generally designated by reference numeral 230). Alternatively or additionally, the printing signal interface comprises a sensor 104 configured to detect the output of the printed product 214.

For example, the sensor 106 of the device 100 is configured to detect the object 102, preferably the conductor 102, (for example, its presence and/or size, preferably width or diameter). Alternatively or additionally, the sensor 106 comprises a button, the actuation of which initiates the provisioning.

Through the material interface 156, the device 100 receives the printed product 214 output by the printer 200. The at least one actuator (for example, at least one of the actuators generally designated herein by reference numerals 120 and 122) of the device 100 may be configured (preferably controlled) to provide (for example, arrange) the marking 101 by means of (i.e., using) the printed product 214 output by the printer 200 in response to the communication with the printer 200 (for example, via the data interface 158) and/or detection of the object 102 (preferably the conductor), for example, using the sensor 106.

For a concise description, and without limitation of the prolate object 102, a conductor is described below as an example of the prolate object 102.

Preferably, the device 100 further comprises an electrical interface 154 for supplying power to the device 100 via the printer 200. Alternatively or additionally, the device 100 may comprise its own power supply, such as a power supply for connection to a power grid or a rechargeable electrical energy storage device (such as a secondary cell).

Optionally, the device 100 comprises a control unit 130 or a regulating unit 130 configured to control or regulate the at least one or each actuator (for example, the actuator 120 and/or 122) of the device 100, for example, according to a controlled variable whose actual value is detected by the sensor 106 as measured values. Alternatively or additionally, the control unit 130 or the regulating unit 130 may be configured to detect or acquire the measured values from the at least one sensor 104 and/or 106 and send them to the printer 200 via the data interface 158. Alternatively or additionally, the control unit 130 or the regulating unit 130 may be configured to receive control commands for controlling or regulating the at least one actuator (for example, the actuator 120 and/or 122) from the printer 200 via the data interface 158 and/or to send control commands for controlling or regulating the printer 200 to the printer 200 based on measured values of the at least one sensor 106.

The printed product 214 may be a printing medium 208 printed by the printer 200. The printing medium 208 may be a printable tape (preferably plastic tape or adhesive tape) or a printable film (preferably plastic film or adhesive film). The printable film may comprise a self-adhesive layer on a side opposite the printing, or may be heat-sealable (or weldable) to itself (preferably at an end) and/or to the conductor by the application of heat. Alternatively or additionally, the printing medium 208 may comprise a tube (for example, a heat shrink tube).

The first actuator 120 (also: cutting unit) may be configured to cut the printed product 214. The cutting unit may be configured to cut the printed product 214 in a transverse direction 121 transverse, preferably perpendicular, to the longitudinal direction of the printed product 214. Alternatively or additionally, the second actuator 122 may be configured to provide the cut printed product 214, preferably to arrange it on the conductor.

The marking 101 may comprise a portion of the printed product 214, for example a portion of the printed product 214 cut by the device 100 using the at least one actuator (for example, 120 and/or 122). The marking 101 may also be referred to as a label.

The marking 101 may be a printed wrap-around label, a printed flag label, or a printed section of the tube.

The application of the marking 101 to the conductor 102 may comprise a material connection of the marking 101 to the conductor 102. For this purpose, the marking 101 may be self-adhesive or bondable by heat. For example, the marking 101 may be a flag label that is wrapped around the conductor 102 during application and connected to itself in a two-dimensional manner at both ends of the marking 101. In another example, the marking 101 may be a wraparound label that is wrapped around the conductor 102 and connected to itself over a surface (or in a two-dimensional manner) during application. Alternatively or additionally, applying the marking 101 to the conductor 102 may comprise a positive-fit connection (for example, movable in the longitudinal direction of the conductor) of the marking 101 to the conductor 102. For this purpose, the marking 101 may comprise a tube (for example, a shrink tube) and/or a film (for example, a weldable thermoplastic film) that can be bonded to itself at the ends (preferably by the action of heat).

Applying the marking 101 to the conductor 102 using the at least one actuator 120 or 122 may comprise opening the tube and/or sliding the tube (for example, the shrink tube) as the marking 101 onto the conductor 102, wrapping the marking 101 around the conductor 102, wrapping the marking 101 around the conductor 102 and closing the marking 101 as a flag label, inserting the marking 101 into a transparent grommet on the conductor 102, and/or printing a tag as the marking 101 that may be clipped around the conductor 102.

The device 100 may be configured to apply the marking 101 to the conductor 102 when the conductor 102 is already mounted (for example, when one or more ends of the conductor are contacted and/or are not free ends). For example, during application, the conductor 102 may not be rotated about a transverse axis transverse to the longitudinal direction of the conductor 102, may not be rotated about a longitudinal axis parallel to the longitudinal direction of the conductor 102, and/or may be at rest.

The marking 101 applied to the conductor 102 may be captive. Alternatively or additionally, a printed surface of the applied marking 101 may be flat or substantially free of curvature. For example, the printed surface may be arranged between two embossments. As a result, the printed surface may be easily readable and/or sufficiently large.

The marking 101 may be durable, for example in terms of printing (preferably in that the printer 200 is a thermal transfer printer), in terms of the material of the printing medium 208 (for example in that the printing medium is a plastic film), and/or in terms of attachment to the conductor 102 (for example in that the marking 101 is positively or materially (e.g., firmly bonded or adhesively) connected to the conductor 102).

A marking 101 may be space-saving, for example so that a plurality of conductors 102 each carrying such a marking 101 may be arranged closely together. Alternatively or additionally, the marking 101 may be displaceable (i.e., movable) and/or rotatable, for example by positively connecting the marking 101 to the conductor 102. This may allow the marking 101 to be aligned on conductors 102 (such as cables) that are in close proximity to each other.

The first embodiment of the device 100 shown in FIG. 1 is attached to an embodiment of the printer generally designated by reference numeral 200. While the embodiment of the printer 200 shown in FIG. 1 is shown and described in connection with the first embodiment of the device 100, the other embodiments of the device 100 may also be attachable (preferably alternately) to the embodiment of the printer 200.

The embodiment of the printer 200 comprises a print head 202, a print roller 204 (or platen roller), a light barrier 212 for detecting the printing medium 208 (i.e., the material to be printed), for example, for detecting control holes, (for example, black) control marks, a beginning and/or an end of the printing medium 208. The printing material 206 is, for example, a color ribbon.

The media or material 208 to be printed is guided, along with the color ribbon 206, between the print head 202 and the print roller 204. The light barrier 212 may detect a beginning of the printing medium 208 during printing to ensure positioning of the printed image within the portion of the printed product 214 by means of which the marking 101 is formed.

The printer 200 comprises interfaces that are spatially associated with and/or functionally correspond to the interfaces of the device, respectively. The spatially associated and/or functionally corresponding interfaces are connected or connectable to each other in pairs.

Preferably, the printer 200 comprises a mechanical interface 252 that is connected to, or is connectable to, or in communication or exchange or configured for communication or exchange with the mechanical interface 152 of the device 100. Preferably, the spatial association implies that when the mechanical interface 152 and 252 are connected (e.g., interlocked), the other interfaces of the device 100 and the printer 200 are also mutually connected or brought into communication or exchange.

Alternatively or additionally, the printer 200 comprises a data interface 258 that is connected or connectable to, or in communication or exchange with, the data interface 158 of the device 100. Alternatively or additionally, the printer 200 comprises a material interface 256 that is connected or connectable to, or in communication or exchange with, the material interface 156 of the device 100.

For example, the material interfaces 156 and 256 are in connection, or can exchange, the printed product 214. The data interfaces 158 and 258 are in communication or connection for exchanging measurement data from the respective sensors 104, 106, and/or 212 and/or control commands from the control unit 130 of the device and/or from a control unit 230 of the printer 200.

Optionally, as shown by way of example in FIG. 1, the printer 200 comprises an interface 222 to a computer or computer network 300 (for example, a connection to the Internet). The printer 200 (for example, its controller or control unit 230) may receive print jobs via the interface 222.

The device 100 for applying the marking 101 to the conductor 102 is also referred to as an applicator.

An embodiment of the applicator 100 (for example, the aforementioned first embodiment of the applicator 100) or a printing system (for short: system) comprising an embodiment of the applicator 100 and an embodiment of the printer 200 (for example, the aforementioned embodiment of the printer) are configured to perform one or more of the following functions and method steps.

The applicator 100 and the printer 200 may perform operations (which are also referred to as actions), i.e., a set of one or plurality of process steps, alternately, in particular when applying the marking 101 to the conductor 102. In doing so, the applicator 100 and the printer 200 communicate with each other via the data interfaces 158 and 258, respectively, for example, in order to coordinate parameters and/or timing of the operations (preferably of the next operation in each case). The alternating execution of the operations is also referred to as interleaved operation of the applicator 100 and the printer 200.

In a first implementation, an overall procedure control (or sequence control) is stored (e.g., implemented or executably stored) in the printer 200, for example, in the control unit 230 (preferably using firmware stored in the control unit 230). The overall procedure control may comprise printing on the printing medium 208 and applying the printed product 214 resulting from the printing.

A procedure control (or sequence control) of the applicator 100 may be stored (e.g., implemented or executably stored) in the applicator 100 and/or the printer 200. The procedure control of the applicator 100 may comprise (preferably exclusively) applying the marking 101 to the conductor 102 using the printed product 214. For example, the marking 101 is applied to the conductor 102 by executing the procedure control of the applicator 100.

In other words, executing the procedure control of the applicator 100 may be partially or entirely in the applicator 100 or exclusively executed in the printer 200. In any case, executing the procedure control of the applicator 100 causes the marking 101 to be applied to the conductor by means of the applicator 100.

In a first variant of the first implementation, the procedure control (e.g., sequence control) of the applicator 100 is stored in the printer 200. The applicator 100 preferably does not have any sequence control, for example, it also does not have a control unit 130. The control unit 230 of the printer (for example, the firmware of the printer 200 in the control unit 230) is configured to (preferably individually) control (or drive) the actuators (for example 120 and/or 122) or (preferably individually) query (or detect) the sensors (for example, 104 and/or 106) of the applicator 100 via the data interfaces 158 and 258.

In a second variation of the first implementation, the procedure control (e.g., sequence control) of the applicator 100 is stored (e.g., implemented or executably stored) in the applicator 100. For example, the applicator 100 comprises the control unit 130 or the regulating unit 130 in which the sequence control of the applicator 100 is stored (e.g., implemented or executably stored). Preferably, the control unit 130 or the regulating unit 130 is configured to control or regulate the applicator. For simplicity and without limitation, reference is made herein to the control unit 130, i.e., the function of a regulator (e.g., closed-loop control) is optionally comprised.

The execution of the procedure control (or sequence control) (preferably in the control unit 130) is started by the printer 200 (for example, the control unit 230, preferably by means of the printer firmware). For this purpose, the applicator 100 may receive a control command via the data interface 158 or may be energized via the electrical interface 154. As soon as an operation of the applicator 100 is required, the printer 200 (for example, the control unit 230, preferably by means of the printer firmware) sends a signal as a control command to the applicator 100 via the data interface 258 or 158.

Preferably, the printer 200 waits while the applicator 100 performs the requested operation (for example, initiated by the control command). As soon as the applicator 100 sends (e.g., reports) a signal via the data interface 158 or 258 as a control command of completion of the operation, the printer 200 continues execution of the overall procedure control.

Optionally, the signal from the applicator 100 to the printer 200 indicates a status of completion of the operation. For example, the status may indicate successful completion or an error that occurred during execution of the operation.

In a second implementation, the applicator 100, for example the control unit 130 (preferably using firmware of the applicator 100) executes the overall procedure control (i.e., the overall operation). In other words, the overall procedure control is stored (e.g., implemented or executably stored) in the applicator 100, for example, in the control unit 130 (preferably by means of firmware stored in the control unit 130). By executing the overall procedure control, the applicator 100 controls the overall flow.

The printer 200 acts as a slave in the overall operation. For example, the printer 200 has sovereignty over the printed image, i.e., the printer 200 (preferably its control unit 230) performs the printing as an operation of the printer 200 in response to a corresponding control command from the applicator 100. Optionally, the printer 200 issues a control command (i.e., a first start command) to execute the overall procedure control, for example, because only the printer 200 knows about the content and/or the presence of a print job.

To implement the interleaved (or alternating or nested) operation, the applicator 100 and the printer 200 exchange information (for example, measurement data and/or control commands) using the data interface 158 and 258, respectively.

The exchanged information may comprise measured values (for example, electrical voltages, electrical currents, electrical frequencies), preferably measured values of the sensor 104 and/or 106, which are transferred (i.e., sent) from the applicator 100 to the printer 200. Alternatively or additionally, measured values of a sensor of the printer (for example, the light barrier 212) may be transferred (i.e., sent) from the printer 200 to the applicator 100. The applicator 100 or the printer 200 may determine (for example, calculate) sequence control parameters based on the measurands (or measured values) and/or transmit the measured values or the parameters to the computer or computer network 300 (for example, to application software) via the interface 222.

For example, the sensor 106 may detect (or sense or acquire) a diameter or circumference of the conductor 102 (or the prolate object about its longitudinal axis). The control unit 130 and/or the control unit 230 may determine a length of a feed of the printing medium 208 and/or a selection of the printing medium 208, for example, depending on the detected (or sensed or acquired) diameter or circumference.

Furthermore, when a defined threshold value is exceeded, these measured values may be transferred as a digital signal (for example, either as a state “0” or a state “1”) to the data interface 158 or 258, respectively, in order to indicate to the other (printer 200 or applicator 100) that a defined state (for example, the completion of an operation) has been reached. For example, reaching an end position or a reference point of an actuator (for example, the actuator 120 and/or 122) may be indicated.

A reference move (or reference run) of an actuator of the applicator 100 (for example, the actuator 120 and/or 122) may be used to mechanically move an actuator (i.e., a drive connected to a mechanism of the applicator 100) to a determined position of the actuator (i.e., the mechanism), referred to as a reference position. A control command from the printer 200 or a process step of the operation, sequence control, and/or overall sequence control performed by the applicator 100 may comprise a motion (for example, a travel command) of the actuator, with the reference position serving as a reference point for the motions.

If the control unit 130 of the applicator 100 (for example, the applicator firmware) calculates one or more parameters of the applying (i.e., procedure control) from measured values (for example, transferred from the printer 200 or detected by the sensor 104 and/or 106), the parameter(s) may be transferred to the control unit 230 of the printer 200 (preferably to the printer firmware thereof) in accordance with a communication protocol via the data interface 158 and 258. Furthermore, the control unit 130 of the applicator 100 (preferably its applicator firmware) may also use measurement data detected or acquired by the printer 200 (for example, measurement data from the light barrier 212) to control the sequence control of the applicator (for example, as parameters of the applicator).

The printer 200 may be configured to print normal labels, for example, when no device 100 is attached to the mechanical interface 152 and/or the data interface 158.

The printer 200 may be a thermal transfer printer. The thermal transfer printer may provide high contrast and consistent marking 101. For example, the printer 200 may be a thermal transfer roll printer.

The embodiment of the printer 200 comprises an unroller 216 (or source roller) of the print media 208 disposed upstream of the print head 202, an unroller 218 of the print media 206 disposed upstream of the print head 202, and a rewinder 220 (or target roller) of the print media 206 disposed downstream of the print head 202.

An electrical interface 254 of the printer 200 is configured to supply electrical power to the applicator 100 attached to the printer via the electrical interface 154 thereof.

Optionally, the printer comprises a display 209, preferably user interface with a touch-sensitive screen. The control unit 230 and/or regulating unit 230 of the printer 200 may be in signal communication with the display 209, for example, to display a message or to select or enable a print job.

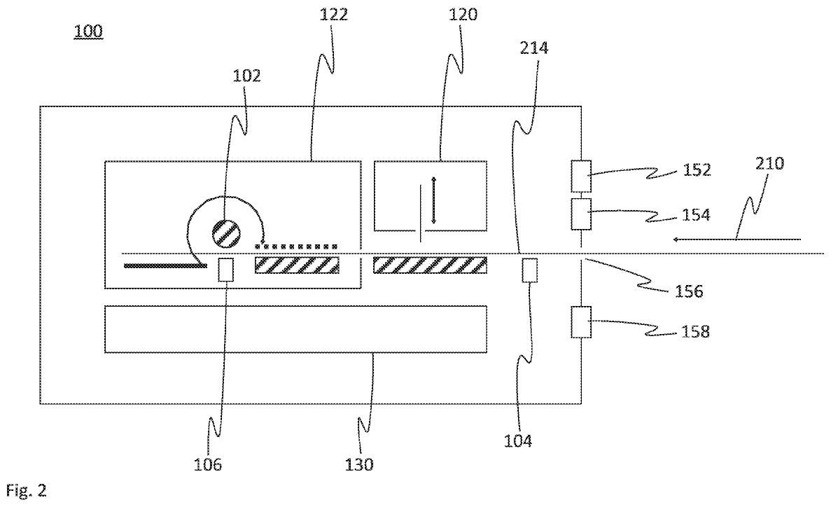

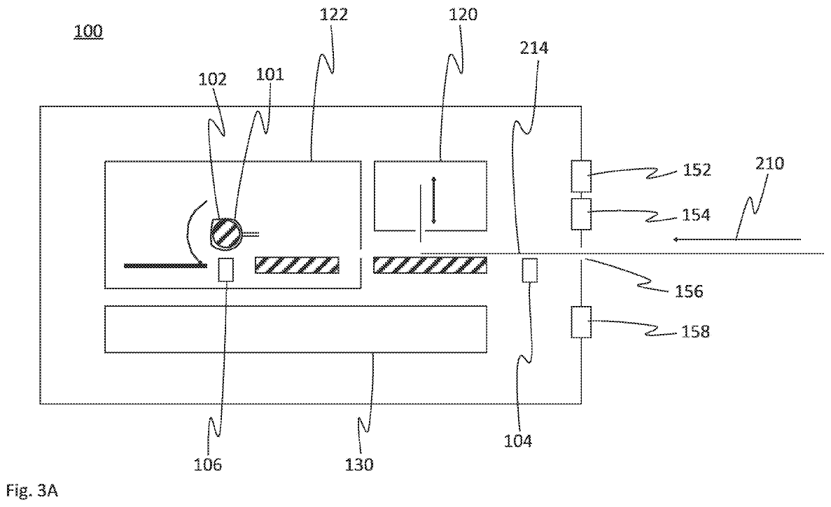

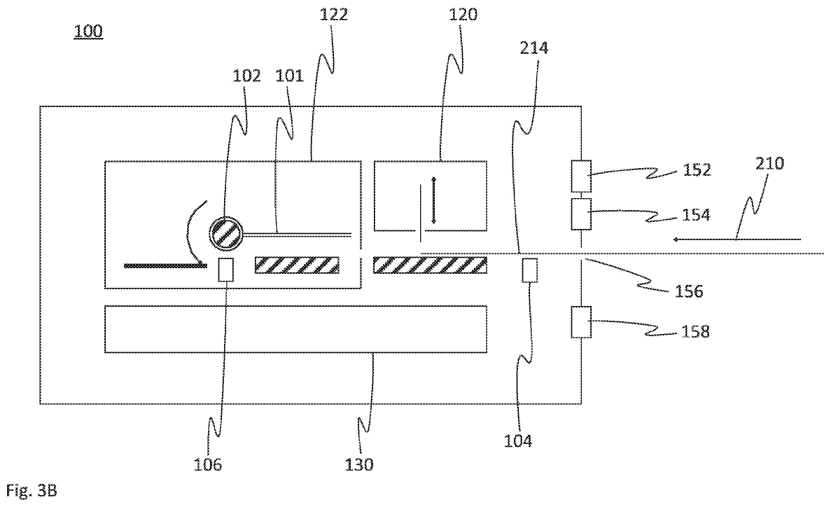

FIGS. 2 and 3A show a schematic cross-sectional view of a second embodiment of the applicator 100 (i.e., the device 100 for applying) a printed marking in a first state and a second state of application, respectively.

The second embodiment of the applicator 100 may be implemented independently or in further extension of the first embodiment of the applicator 100. Features of the first and second embodiments of the applicator 100, denoted by the same reference numerals, may be identical or interchangeable.

The second embodiment of the applicator 100 is configured to strike or fold a printed film as a printed product 214 around the conductor 102 using a second actuator 122 of the applicator 100. Preferably, the sensor 106 determines the diameter of the conductor 102. The control unit 130 calculates a length from the diameter and controls the printer (more specifically, its print roller 204) via the data interface 158 to feed the printed product 214 according to the determined length.

After the feed, for example in the first state shown in FIG. 1, the printer 200 signals via the data interface 258 (i.e., to the data interface 158) that the feed has been successfully completed, for example that the determined length has been reached. In response to the message from the printer 200, the control unit 130 controls the actuator 122 to wrap or fold the printed product 214 around the conductor 102. Further, the second actuator 122 (or, in one variant, a further actuator) is configured to heat weld together sections of the printed product 214 that lie flat on top of each other. Preferably, a first actuator 120 of the applicator cuts the welded sections to a flush end of the marking 101.

In a first variant of the second embodiment of the applicator 100, a portion of the surface surrounding the conductor 102 is printed and the flush cut end is short compared to the circumference of the conductor 102. Preferably, the applying, i.e., a step of the procedure control of the applicator 100, comprises two embossings performed on the printed product before and after the printed portion using the actuator 120, as schematically shown in FIG. 3A.

For example, the procedure control of the applicator 100 may comprise at least one of the following operations or steps. In one step, a control command is sent from the control unit 130 to the printer 200. The control command specifies the feed rate of the printed product 214 for a reference cut. In another step, in response to a notification of completion of the feed from the printer 200 to the applicator 100, the reference cut is executed by the actuator 120. A further step of the procedure control of the applicator 100 may comprise waiting until the presence of the conductor 102 is detected or acquired by means of the sensor 106. Another step of the procedure control (i.e., the procedure control sequence) of the applicator 100 may comprise acquiring the diameter of the conductor 102 by means of the sensor 106 and calculating parameters of the applying (for example, partial lengths for feeds of the printed product 214).

In a further step, a further control command is sent from the control unit 130 to the printer 200. The further control command indicates a first partial feed of the printed product 214 for a first embossing. In a further step, in response to a notification of completion of the first partial feed from the printer 200 to the applicator 100, the first embossing is performed by the actuator 120.

In a further step, a further control command is sent from the control unit 130 to the printer 200. The further control command specifies a second partial feed of the printed product 214 for a second embossing. In a further step, in response to a notification of completion of the second partial feed from the printer 200 to the applicator 100, the second embossing is performed by the actuator 120.

In a further step, a control command is sent from the control unit 130 to the printer 200 indicating a partial feed of the printed product 214 for a cutting position. In a further step, in response to a notification of completion of the partial feed for the cutting position from the printer 200 to the applicator 100, the cut is performed by the actuator 122, the printed product is wrapped or folded around the conductor 102, sealing portions of the printed product 214 brought into contact with each other in a planar manner, and a cut performed by the actuator 120.

In a second variant of the second embodiment of the applicator 100, the flush cut end is equal to or longer than the diameter of the conductor 102 and comprises the printed portion of the printed product 214, as schematically shown in FIG. 3B.

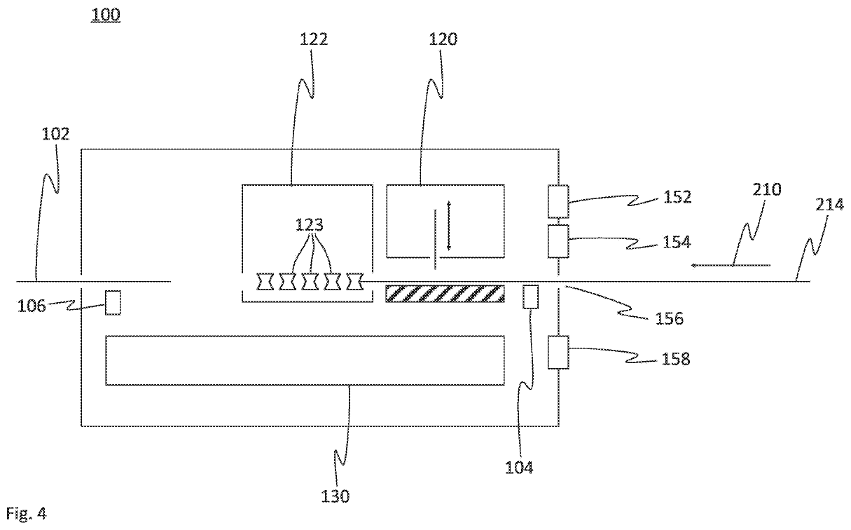

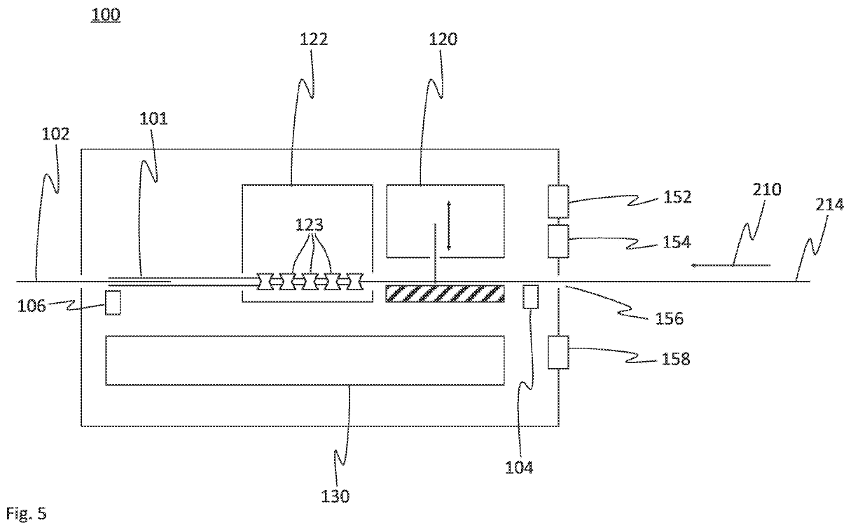

FIGS. 4 and 5 show a schematic cross-sectional view of a third embodiment of the applicator 100 (i.e., the device 100 for applying) a printed marking in a first state and a second state of application, respectively.

The third embodiment of the applicator 100 may be implemented independently or in further embodiment of the first and/or second embodiment of the applicator 100. Features of the first, second, and third embodiments of the applicator 100 designated by the same reference numerals may be the same or interchangeable.

The third embodiment of the applicator 100 is configured to slide or put on the conductor 102 a tube (for example, a heat-shrink tube) as a printing medium 208 or a printed tube as the printed product 214. When the tube is printed and/or cut (for example, by means of the first actuator 120 of the applicator), the tube is pressed flat, whereby its cut end or at least a portion of the printed tube may be closed, i.e., the cut edge or the inner sides of the tube adhere to each other.

The second actuator 122 (also: opening unit) is configured to open the cut edge of the printed tube adhering together and/or the inner sides (for example, an upper tube half and a lower tube half) of the printed tube adhering together. To this end, the second actuator 122 comprises waisted rollers 123 that apply a force in pairs to opposite lateral edges of the printed tube 214 to open the cut edge of the tube and/or to release the inner sides of the tube from each other. In the schematic illustration of FIGS. 4 and 5, one of each of the pairs of oppositely disposed rollers 123 is visible as the pairs are aligned perpendicular to the longitudinal direction or direction of movement 210.

In the second state shown in FIG. 5, the printed tube is opened by means of the second actuator 122, pushed onto the conductor as a marking 101 due to a feed of the printer 200, and cut off at the end by means of the first actuator 120.

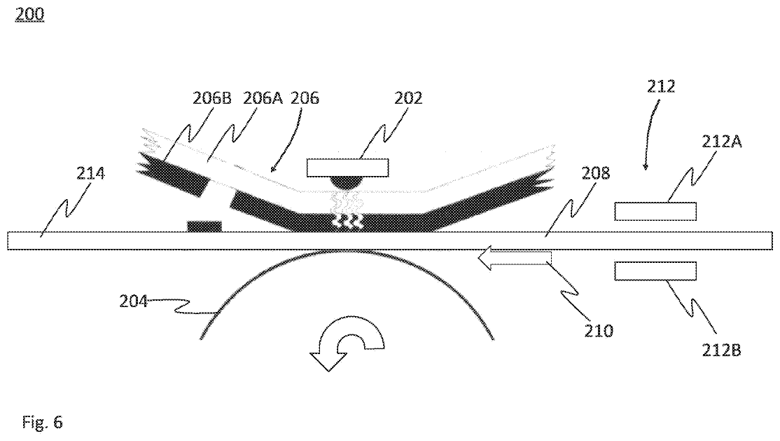

FIG. 6 shows a further embodiment of the printer 200, which may be implemented independently or as a further development of the embodiment of the printer 200 described in the context of FIG. 1. Features of the embodiments designated by the same reference numerals may be identical or interchangeable. The further embodiment of the printer 200 is an example of a thermal transfer roll printer.

A control unit 230 of the printer 200 controls a feed and/or a retraction of the printing medium 208 at the print head 202 and/or of the printed product 214 at the material interface 256 (and consequently at the material interface 156 of the device 100), depending on the signals from the light barrier 212 and/or control commands obtained from the device 100 via the data interface 258 (i.e., via the data interface 158 of the device 100). For this purpose, the control unit 230 may control a drive (for example, a stepper motor) for rotating the print roller 204.

The light barrier 212 may be arranged upstream of the print head 202 and/or the print roller 204 with respect to a direction of movement 210 of the printing medium 208 during advancement. The light barrier 212 may comprise, as exemplarily shown in FIG. 6, a light source 212A on the side of the print head 202 and a light sensor 212B on the side of the print roller 204. In a first variation, the positions of light source 212A and light sensor 212B may be interchanged. In a second variation, light source 212A and light sensor 212B may be arranged on the same side for detecting the printing medium 208 in reflection.

The print head 202 comprises a plurality of heating elements. When the heating elements are heated (for example, energized) and the print roller 204 applies a predetermined (for example, sufficiently large) pressure to the printing medium 208, the color pigments are transferred from the printing material 206 (for example, a color ribbon) to the material to be printed. The control unit 230 may control the stepper motor to rotate the print roller 204 and control the energization of the heating elements of the print head 202.

The printing material 206 may comprise a plurality of layers. For example, the printing material 206 may comprise a carrier material 206A (for example, a carrier film) facing away from the printing medium 208 and a color layer 206B (for example, a color wax) facing toward the printing medium 208.

The printer 200 is preferably a tabletop device to which the device 100 may be attached as a replaceable or interchangeable module, for example, specific to an application or for the duration of a uniform application process.

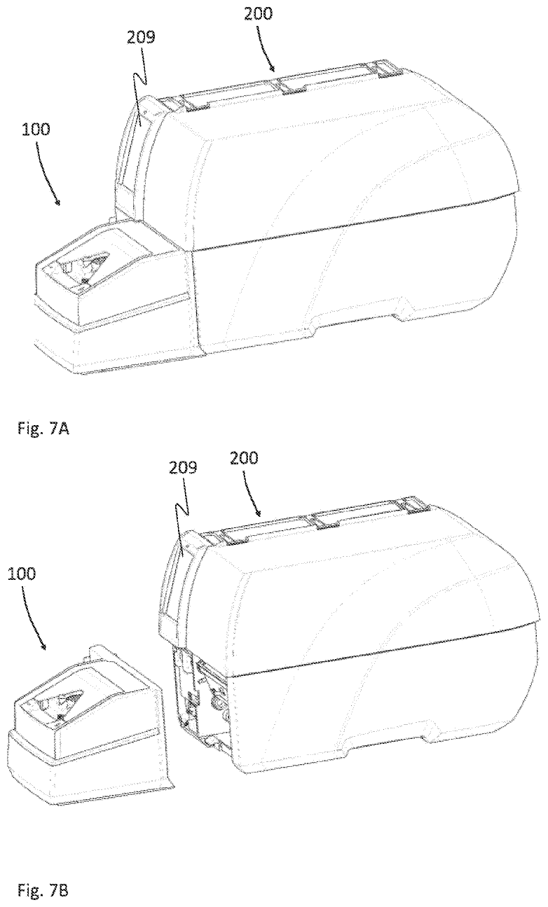

FIG. 7A shows a schematic perspective view of an exemplary printing system (system for short), comprising an embodiment of the printer 200 and an embodiment of the device 100. In an exemplary mounted position of the device shown in FIG. 7A, all implemented physical interfaces are connected due to the arrangement of the device 100 on the printer 200. FIG. 7B shows a schematic perspective view of the exemplary printing system of FIG. 7A in a disassembled position. The physical interfaces are exposed.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Device for providing a marking,
e.g., an applicator 100
Marking (or label) 101
Prolate object, preferably conductor,
e.g. copper conductor or light guide 102
Print signal interface of a control signal related to outputting of a printed product,
e.g., a sensor for detecting the printed product 104
Sensor of a control signal related to the providing of the marking,
e.g., a sensor for detecting the object or
a sensor for acquiring a request for the provisioning 106
First actuator of the device, e.g., cutting unit 120
Transverse direction 121
Second actuator of the device 122
Waisted rollers of the second actuator 123
Control unit or regulating unit of the device 130
Mechanical interface of the device 152
Electrical interface of the device 154
Material interface of the device 156
Data interface of the device 158
Printer, e.g., thermal transfer printer 200
Print head of the printer 202
Print roller of the printer 204
Printing material, e.g., ribbon 206
Carrier material of the printing material, e.g., carrier foil 206A
Color layer of the printing material, e.g., color wax 206B
Printing medium of the printer (also: label material) 208
Display, preferably user interface, of the printer 209
Feed direction or longitudinal direction of the printing medium 210
Light barrier of the printer 212
Light source of the light barrier 212A
Light sensor of the light barrier 212B
Printed product of the printer 214
Unwinder of the printing medium 216
Unwinder of the printing material 218
Rewinder of the printing material 220
Data interface of the printer 222
Control unit of the printer 230
Mechanical interface of the printer 252
Electrical interface of the printer 254
Material interface of the printer 256
Data interface of the printer 258
Computer or computer network 300

1: A device for providing a marking arranged or arrangeable in a circumferentially closed manner around a prolate object, comprising:
a material interface configured to receive a printed product output from a printer;
a print signal interface configured to acquire a control signal related to the printed product output;
at least one sensor configured to acquire a control signal related to the providing of the marking; and
at least one actuator configured to arrange the marking on the object in a circumferentially closed manner or to provide the marking for circumferentially closed arrangement depending on the control signal related to the printed product output and the control signal related to the providing of the marking using the printed product output by the printer.

2: The device of claim 1, further comprising:
a mechanical interface configured to releasably or irreversibly attach the device to the printer.

3: The device of claim 1, wherein the at least one sensor of the control signal related to the providing of the marking is configured to detect the object.

4: The device of claim 1, wherein the at least one sensor of the control signal related to the providing of the marking comprises a button, and the control signal related to the providing of the marking indicates an actuation of the button.

5: The device of claim 1, wherein the print signal interface comprises a sensor configured to detect the printed product output by the printer.

6: The device of 2, wherein the print signal interface comprises a data interface configured to communicate with the printer for the providing or the arranging of the marking.

7: The device of claim 6, wherein the data interface is configured for wireless communication.

8: The device of claim 6, wherein the data interface is configured to synchronize or coordinate an alternating and/or event-driven operation of the at least one actuator and the printer for the providing or the arranging of the marking.

9: The device of claim 6, wherein the data interface is configured to enable the printer to control the at least one actuator of the device, to read out the control signals of the at least one sensor and/or the print signal interface of the device and/or an identifier stored in the device.

10: The device of claim 6, wherein the data interface is configured to receive control commands for controlling or regulating the at least one actuator from the printer and/or to send control commands for controlling or regulating the printer to the printer based on the control signals from the at least one sensor and/or the print signal interface.

11: The device of claim 6, wherein the data interface is configured to send control signals of the at least one sensor and/or the print signal interface and/or parameters determined from the control signals to the printer for the providing or the arranging of the marking.

12: The device of claim 1, further comprising
a control unit or a regulating unit configured to control or regulate the at least one actuator of the device for the arranging or the providing of the marking depending on the control signals of the at least one sensor, measured values of the printer received via the data interface, confirmation messages of the printer received via the data interface, and/or control commands of the printer received via the data interface.

13: The device of claim 12, wherein the control unit or the regulating unit is configured to obtain a control command from the printer via the data interface, to execute the controlling or the regulating of the at least one actuator in accordance with the control command, and to send a feedback to the printer via the data interface in response to completion of the executing of the control command.

14: The device of claim 12, wherein the control unit or the regulating unit is configured to determine a parameter of the arranging based on the control signal acquired using the at least one sensor and to send the determined parameter to the printer via the data interface.

15: The device of claim 14, wherein the acquired control signal is indicative of a diameter or circumference of the object, and the determined parameter is indicative of a length of an advance or a retract of the printed product.

16: The device of claim 14, wherein a control command sent from the device to the printer via the data interface initiates the advance or retract.

17: The device of claim 13, wherein the control unit or the regulating unit autonomously performs the providing or the arranging of the marking, or a sub-step of the providing or the arranging of the marking, in accordance with the control command during a time period between obtaining the control command from the printer and sending the feedback to the printer.

18: The device of claim 6, further comprising:
an electrical interface configured to supply electrical power to the device via the printer.

19: The device of claim 18, wherein the data interface and/or the electrical interface is arranged relative to the mechanical interface to contact the printer for the communicating and for the supplying of electrical power, respectively, when the device is attached to the printer by means of the mechanical interface.

20: The device of claim 1, wherein the object comprises an electrical conductor or a light guide.

21: The device of claim 1, wherein the mechanical interface comprises a centering pin or an opening for receiving a centering pin, and/or
wherein the mechanical interface comprises a lever and an eccentric connected to the lever in a rotationally fixed manner, the eccentric being configured to attach the device to the printer without screws and/or without tools.

22: A system for providing a marking arranged or arrangeable in a circumferentially closed manner around a prolate object, comprising:
a printer configured to output a printed product; and
the device of claim 1,
wherein the material interface is arranged, relative to the printer, to receive the printed material output by the printer.

23: The device of claim 1, wherein the prolate object comprises a conductor.
